(19) United States
(12) Patent Application Publication
(10) Pub. No.: US 2022/0064992 A1
(43) Pub. Date: Mar. 3, 2022

(54) MAGNETIC LATCH AND METHODS OF USE

(71) Applicant: Guidecraft, Inc., Tuxedo Park, NY (US)

(72) Inventors: Andrew T. Williams, Warwick, NY (US); Hongwei Fu, Ningbo (CN); Matthew Marceron, Winston-Salem, NC (US)

(21) Appl. No.: 17/010,049

(22) Filed: Sep. 2, 2020

(51) Int. Cl. E05B 47/00; E05B 17/00; E05C 19/16; E05B 65/44; A47D 7/02

(52) U.S. Cl. CPC E05B 47/004; E05B 17/0033; E05Y 2900/20; E05B 65/44; A47D 7/02; E05C 19/163

(57) ABSTRACT

A latching apparatus and method for latching two separable apparatuses. The latching apparatus includes a moveable actuator and a bolt. The moveable actuator has a bolt facing north-pole magnet and bolt facing a south-pole magnet attached thereto. The bolt moves in response to the north-pole magnet and the south-pole magnet when the bolt is adjacent the actuator.

### CROSS-REFERENCE TO RELATED APPLICATIONS

None

### FIELD OF THE INVENTION

This invention is related to latches and more particularly to apparatuses and methods for magnetically operating a latching bolt.

### BACKGROUND OF THE INVENTION

Latches are used for many purposes including maintaining items in a close position until those items are desired to be open. For example, a baby crib with a drop-down side protects the baby from climbing out of the crib when the crib is latched in a closed position, and can be placed in an open position with the drop-down side dropped for easy access to the baby when the latch is released. Latches, including those disclosed herein, are used in many applications, from door latches to automobile latches and have a variety of methods of use.

Existing latches can be difficult to operate, particularly over time as they wear. They can also engage the user in an uncomfortable or harmful way.

Accordingly, there is a need for a latch that is easy to use and an effective method of using such a latch. There is also a need for a latch that wears minimally. In addition, there is a need for a latch that is comfortable and not harmful to a user.

There is also a need for a latch for a drop-side on a crib that has a soft-closure to protect a young person from having a finger or other body part caught when closing the drop-side and there is a need for a latch for a crib that is difficult for a crib occupant to open.

### BRIEF DESCRIPTION OF THE DRAWINGS

The accompanying drawings, wherein like reference numerals are employed to designate like components, are included to provide a further understanding of latch apparatuses and methods of use, are incorporated in and constitute a part of this specification, and show embodiments of those apparatuses and methods that together with the description serve to explain those apparatuses and methods.

Various other objects, features and advantages of the invention will be readily apparent according to the following description exemplified by the drawings, which are shown by way of example only, wherein:

FIG. 1 illustrates a perspective view of an embodiment of a latch of the present invention from the switch side;

FIG. 2 illustrates a perspective view of the latch illustrated in FIG. 1 from the bolt side;

FIG. 3 illustrates a drop-side crib incorporating a latch to maintain a drop-side in a closed position;

FIG. 4 illustrates the drop-side crib of FIG. 3 with the drop-side in an open position;

FIG. 5 illustrates an exploded view of an embodiment of a latch applied to a crib;

FIG. 6 illustrates the latch of FIG. 5 with the components of latch combined for use on an apparatus with the latch bolt engaged with the strike plate; and

FIG. 7 illustrates an embodiment of a method of using the latch of the present invention.

### SUMMARY OF THE INVENTION

In an embodiment, a magnetic latch of the present invention includes a moveable actuator and a bolt. The moveable actuator has a north-pole magnet (oriented with a north pole generally facing outward toward the bolt) and a south-pole magnet (oriented with a south pole generally facing outward toward the bolt) attached thereto. The bolt is responsive to the north-pole magnet and the south-pole magnet when the bolt is adjacent the actuator. A magnetic force applied to the bolt moves the bolt toward the moveable actuator when the movable actuator is in a first position and moves the bolt away from the moveable actuator when the movable actuator is in a second position.

In another embodiment, a magnetic latch for a drop-side crib includes a moveable actuator having a north-pole magnet and a south-pole magnet, the moveable actuator attached to the crib. A strike is coupled to the crib adjacent the moveable switch. A bolt having a bolt magnet incorporated therein is attached to the drop-side of the crib such that the bolt magnetically engages the strike when the bolt is adjacent the strike and the moveable actuator is in a first position and such that the bolt disengages the strike when the moveable actuator is in a second position.

A method of operating a latch is also provided. That method includes moving an actuator that is attached to a first structure to be latched to a first position, the actuator having a north-pole magnet and a south-pole magnet. In that first position, the actuator causes a magnet associated with a bolt attached to a second structure to be latched to extend into the first structure, thereby latching the first structure to the second structure. Moving the actuator to a second position causes the magnet associated with the bolt to retract from the first structure, thereby unlatching the first structure from the second structure.

Other embodiments, which may include one or more portions of the aforementioned apparatuses and methods or other parts or elements, are also contemplated, and may have a broader or different scope than the aforementioned apparatuses and methods. Thus, the embodiments in this Summary of the Invention are mere examples, and are not intended to limit or define the scope of the invention or claims.

### DETAILED DESCRIPTION OF THE INVENTION

Reference will now be made to embodiments of apparatuses and methods of a latch, latching, and operation of a latch, examples of which are shown in the accompanying drawings. Details, features, and advantages of those latches and methods of use will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

For purposes of the description hereinafter, the terms “upper,” “lower,” “right,” “left,” “vertical,” “horizontal,” “top,” “bottom,” “lateral,” “longitudinal,” and derivatives thereof shall relate to the concept as it is oriented in the drawing figures. However, it is to be understood that the concept may assume various alternative variations, except where expressly specified to the contrary. It is also to be understood that the specific devices illustrated in the attached drawings, and described in the following specification, are simply exemplary embodiments of the concept. Hence, specific dimensions and other physical characteristics related to the embodiments disclosed herein are not to be considered as limiting.

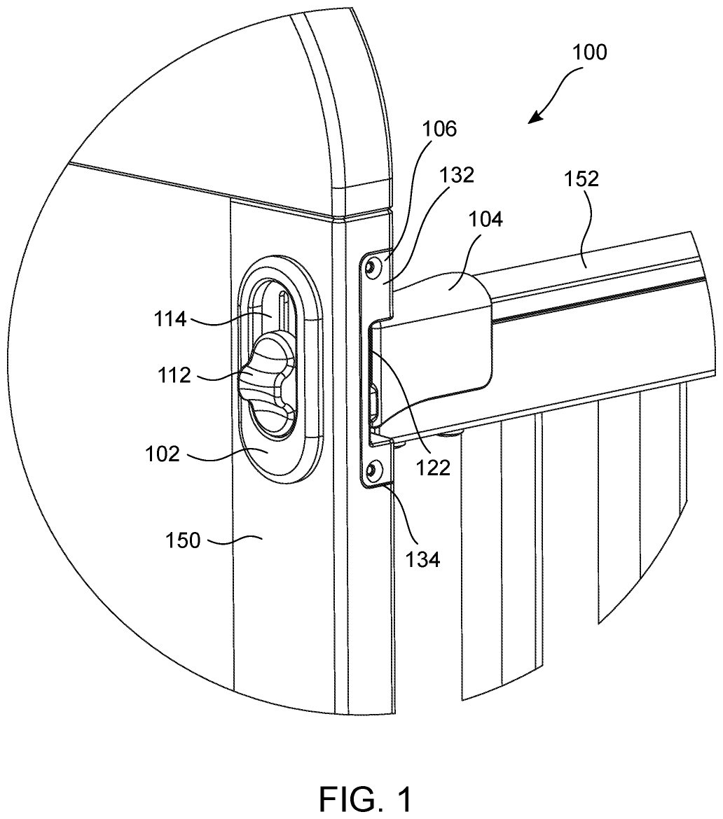

FIG. 1 illustrates a perspective view of an embodiment of a latch 100 of the present invention from the switch side of the latch 100. That embodiment includes a switch assembly 102, a latch mechanism 104, and a strike 106.

In the embodiment shown in FIG. 1, a switch 112 in the switch assembly 102 slides vertically and is set into a fixed strut 150, an upright strut 150 in the embodiment illustrated, against which a moving portion 152, such as a hinged door or drop-side, is to be fastened by way of the latch mechanism 104 coupling with the strike 106. In an embodiment, when the switch 102 is not actuated, a latch bolt 122 in the latch mechanism 104 engages the strike 106.

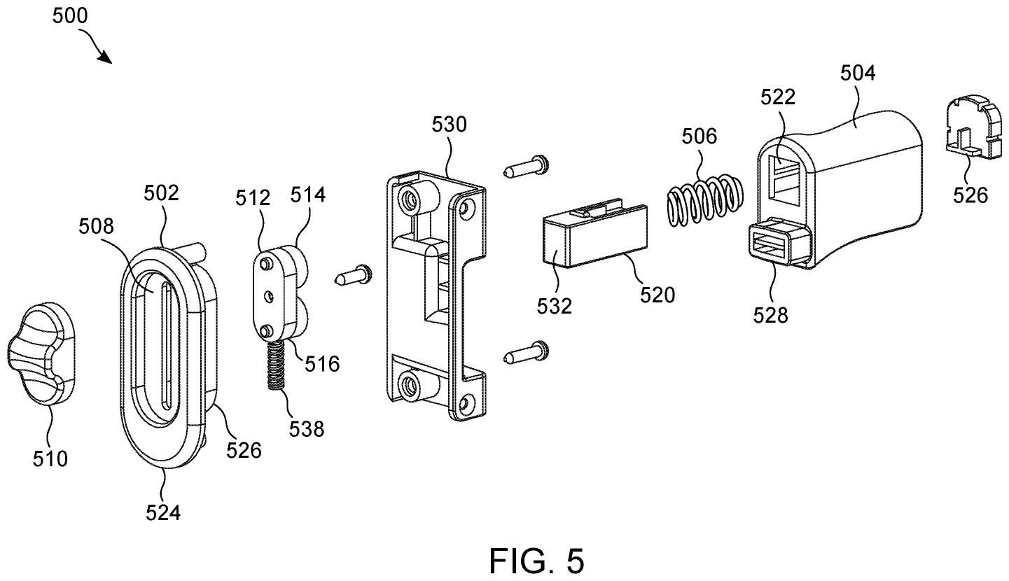

The switch 112 may be biased, for example by a spring 538 (illustrated in FIG. 5), to move the switch 112 to a default position. The switch 112 may be moved to another position by various methods including manually overcoming the bias and repositioning the switch 112. Moreover, the default position may be a latched position, for example, so that latching occurs automatically when the switch 122 is brought into proximate relation with the latch bolt 122.

In the embodiment of FIG. 1, the switch 112 is set into a housing 114 set into the strut 150, which may be part of a frame against which a door is to close in certain embodiments or another structure used in latching. The switch may extend through the housing 114 and couple to a magnet assembly 512 illustrated in FIG. 5.

The strike 106 may include a strike plate 132 that may be attached to the strut 150 or a member attached to the strut 150 or otherwise situated adjacent the strut 150. The strike may also include a strike box 134 set into the strut 150 or a member adjacent the strut 150.

In the embodiment shown in FIG. 1 the latch mechanism 104 is engaged by the switch assembly 102 when the latch mechanism 104 is proximate the latch mechanism 104 and the switch 112 is in its latch position. When the latch mechanism 104 is engaged by the switch assembly 102 being proximate to the strike, the latch bolt 122 will engage the strike 106, thereby retaining the latch mechanism 104 in a position wherein the latch mechanism 104 is maintained adjacent the strike 106.

Alternatively, in an embodiment in which there is no strike 106, the latch bolt 122 may extend into the strut 150 or otherwise engage the strut 150 or a moveable actuator body 502 (Illustrated in FIG. 5) attached to the switch 102 to engage the strut 150.

When the switch 112 is actuated, the latch bolt 122 is disengaged from the strike 106 or strut 150. When the latch bolt 122 is disengaged, the moving portion 152 may be moved away from the strut 150. For example, a door on hinges may be swung away from the switch assembly 102 or a hinged drop-side may be moved away from the switch assembly.

The switch 112 illustrated in FIG. 1 is actuated by manually pushing the switch 112 upward, though another motion could be used as desired. In the embodiment illustrated in FIG. 1, the switch 112 may be biased toward a default position. That position may be a downward and latched position, for example. As may be seen in FIG. 5, a spring 538 may be used to bias the switch 112 moving the switch 112 downward to a latched position when the switch 112 is not being moved upward by manually actuated.

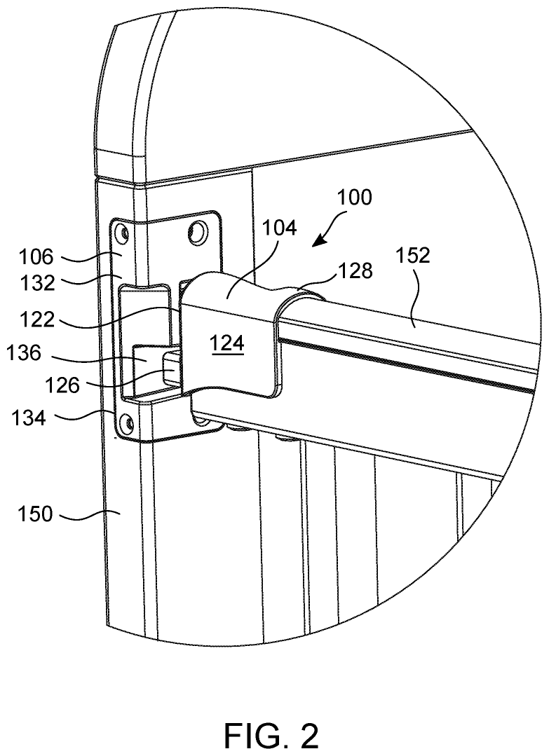

FIG. 2 illustrates a perspective view of the latch 100 of FIG. 1 from the latch mechanism 104 side of the latch 100. The latch mechanism 104 includes a latch housing 124 that may attach to the moving portion 152. The latch mechanism 104 may attach to the moving portion 152 in any desired way, including, for example, by way of one or more screws, interference fit, or snap-coupling prongs. The latch mechanism may also include a latch bolt 122 and a magnet 532 (illustrated in FIG. 5). It should be noted that the latch bolt 122 may itself be magnetized, acting as a magnet 532 or may be of material, such as iron, that is responsive to a magnetic force.

A guide or stop 126 portion of the latch housing 124 may extend into an opening 136 in the strike 106 or strut 150 to guide the latch mechanism 104 into operable relation, proximate to the switch assembly 102. The guide or stop 126 may also prevent the latch mechanism 104 from pivoting past the strike 106 when the latch is moved to the closed position. An attachment portion 128 of the latch housing 124 may be included in the latch housing 124 to facilitate attachment of the latch housing 124 to the moving portion 152.

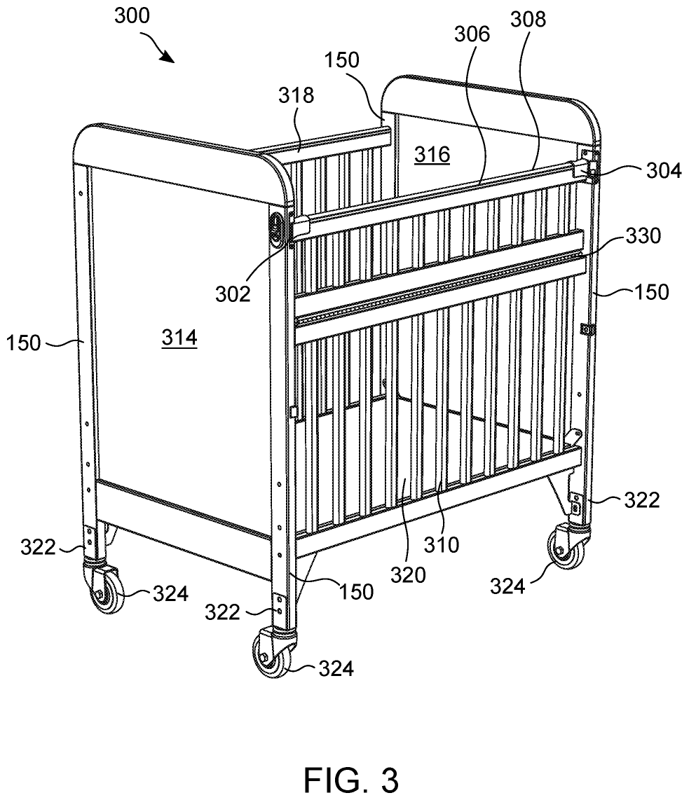

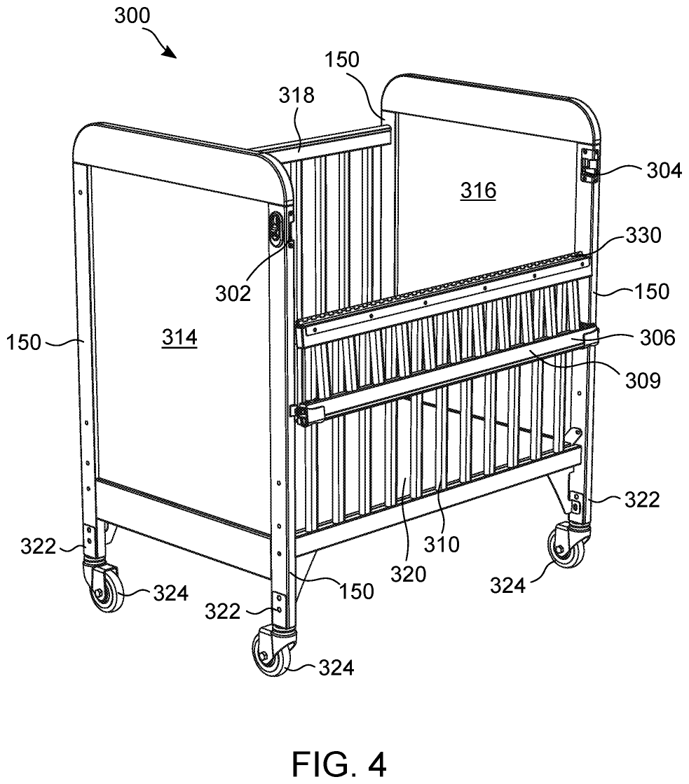

In one embodiment, the present invention has a soft close feature that encourages the user to close a door, drop-side, or other thing to be latched gently or quietly. In one such embodiment, one or more switches 122 must be manipulated to retract associated bolts 122 when moving the latch mechanism 104 to a latching position, for example the position of the drop-side 306 illustrated in FIG. 3. In that embodiment, the user may be required to manually actuate the one or more switches 112, close the drop-side 306 so that the bolt 122 is past a portion of the strike 106 that prevents or minimizes movement of the bolt 122, then release the switches 112 so that the bolts 122 engage the strike 106. When the bolts 122 are engaged with the strike 106, the drop-side 306 is prevented from moving to the dropped position illustrated in FIG. 4. It will be recognized that apparatuses other than the drop-side 306 illustrated may be latched and any number of latches 100 may be utilized.

An advantage to applying more than one latch 100 to an apparatus (use of two latches sometimes referred to as double action), such as a crib 300 is that while a parent or guardian may be able to manipulate two switches 112 on opposite sides of the crib 300 to release those two latches 100, a child in the crib 300 may not be able to reach both switches 112 simultaneously and so could not open the drop-side 306. Further, in the crib 300 application illustrated in FIGS. 3 and 4, the switches 112 are outside the crib 300 making the switches 112 difficult to reach for an occupant of the crib 300.

In another embodiment, an auto-latching latch 100 is disclosed. In the auto-latching latch 100, the latch 100 may be closed against the strike plate 132 and the bolt 122 will engage with the strike plate 132 if sufficient force is applied to close the latch 100 against the strike plate 132. In such an auto-latching embodiment, the strike plate 132 may beneficially move the latch bolt 122 to a retracted position when the latch bolt 122 is pressed against the strike plate 132. Thus, for example, when the latch 100 is used in an application such as the crib 300 illustrated in FIGS. 3 and 4, the drop-side 306 may be moved from an open position 309 to a closed position 308 and the latch bolt 520 will be moved away from the actuator 510 when the latch bolt 520 engages the strike plate 132. Such bolt 122 retraction may be caused by, for example, an angular shaped strike plate 530 that the bolt presses against, the angular strike plate 530 pressing or guiding the bolt 122 to a retracted position. Once the drop-side 306 reaches its fully closed position 308, the magnets 514 and 516 (illustrated in FIG. 5) associated with the actuator 510 may attract the latch bolt 520 to engage the strike plate 530 if the actuator 510 is in the correct position, thus placing the latch bolt 520 behind or inside a void in the strike plate 530, thereby retaining the drop-side 306 in its closed position 308.

In one embodiment, a magnetic latch includes two parts, a moveable actuator 510 that may be in the form of a switch assembly 102, having a north-pole magnet 514 and a south-pole magnet 516 as illustrated in FIG. 5 and a separate latch bolt 122 having a bolt magnet 532. The bolt 122 can generally be moved in relation to the actuator 510 such that the bolt 122 may be moved away from the actuator 510 when unlatched and the bolt 122 may move toward or be adjacent the actuator 510 when latched.

The bolt 122 is responsive to the positioning of the north-pole magnet 514 and the south-pole magnet 516 in the actuator 510 and may be configured in various ways. In one embodiment, the bolt 122 is associated with a magnet and in another embodiment, the bolt 122 itself is magnetic, such that the bolt 122 is also the bolt magnet 532. In both such configurations a magnetic force is applied to the bolt magnet 532 through the north-pole magnet 514 or the south-pole magnet 516 and that force moves the bolt 122 toward the moveable actuator 510 when the movable actuator 510 is in a first position and moves the bolt 122 away from the moveable actuator when the movable actuator 510 is in a second position. The bolt magnet 532 may be oriented with its north pole facing the actuator 510 or with its south pole facing the actuator 510 as desired, such that one of the magnets 514 and 516 may attract the bolt magnet 532 when the actuator 510 is in an appropriate position and the other of magnets 514 and 516 may repel the bolt magnet 532 when the actuator 510 is in a different appropriate position.

In certain embodiments, a spring 538 may bias the bolt 122 toward the actuator 510 and the biasing force of the spring will be overcome when the appropriate actuator magnet 514 or 516 is placed in a position to push the bolt 122 away from the actuator 510 to disengage the latch 100, as is illustrated in FIG. 5. In such embodiments, it may be that only one switch assembly magnet 514 and 516 is included in the magnet assembly 512 and no bolt magnet may be included since a bolt that is responsive to the actuator magnet may be adequate for operation in such a single magnet embodiment.

In other embodiments, a spring may bias the bolt 122 away from the actuator 510 and the biasing force of the spring will be overcome when the appropriate actuator 510 magnet 514 or 516 is placed in a position to pull the bolt 122 toward the actuator 510 to engage the latch 100.

In various embodiments, one or both of the actuator 510 and the bolt 122 may have housings that couple the actuator 510 or the bolt 122 to an apparatus to be latched. Furthermore, in many embodiments, a strike plate 132 is attached opposite the bolt 122 and near the actuator 510 such that the bolt 122 can engage the strike plate to latch the two portions of the apparatus when the actuator 510 is placed in a latching position.

FIG. 3 illustrates a drop-side crib 300 incorporating a first latch 302 and a second latch 304 of the type described herein to maintain the drop-side 306 in a closed position 308 and release the drop side 306 to an open position 309 illustrated in FIG. 4. The crib 300 illustrated in FIG. 3 has a fixed front side 310 attached to a front drop side 306, a back side 318 parallel to the fixed front side 310, and a left side 314 and a right side 316, the left and right sides 314 and 316 each attached to the fixed front-side 310 and the back-side 318. The front-side 310, drop-side 306, and back-side 318 may furthermore attach to struts 150 on the left and right sides 314 and 316 respectively. The crib 300 also has a base 320 that rests between the fixed front side 310 and back side 318 and between the left side 314 and the right side 318. The embodiment of the crib 300 illustrated in FIG. 3 is supported by four legs 322 that may have wheels 324.

A hinge 330 connects the drop side 306 to the fixed front side 310 of the crib 300 in the embodiment illustrated in FIG. 3. Various embodiments may use multiple hinges 330, such as those normally used on a standard door, a piano hinge, such as illustrated, another attachment mechanism, or no attachment, for example in an embodiment that envisions complete removal of a portion of an apparatus when one or more latches 100 are released from an engaged latch position. Moreover, latches 100 may be used individually, in pairs, or in any desired quantity. For example, in the crib 300 illustrated in FIG. 3, two latches 302 and 304 are employed to secure a wide drop-side 306 near each of the drop side 306 upper corners. Those latches 302 and 304 are conveniently and comfortably located for contemporaneous actuation by a left hand and a right hand of a single individual. The first latch 302 is incorporated into the crib 300 near the upper left corner of the drop-side 306 and the second latch 304 is incorporated into the crib 300 near the upper right corner of the drop side 306 with the crib 300 oriented as depicted in FIG. 3.

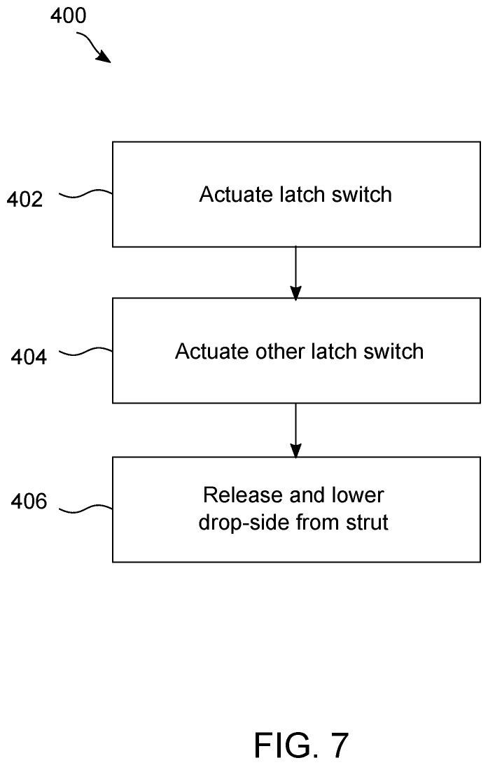

As may be seen in the method of operating the drop-side 306 of the crib 300 in FIG. 7, the first latch 302 and the second latch 304 may be actuated simultaneously to permit movement of the drop-side 306 from its closed position 308 to its open position 309. In other latched mechanisms, for example those having multiple moving parts, one of multiple latches 100 may be actuated at a time.

FIG. 7 illustrates an embodiment of a method 400 of using one or more of the presently described latches 100. At 402, the first latch 302 is actuated by moving the first latch switch 102 and at 404, the second latch 304 is actuated similarly. Movement of the first and second latch switches 102, is limited and restrained by switch 102 being placed in the switch housing 114 and the switch housing 114 permitting the switch 102 to be moved only vertically. The first latch 302 switch 102 and second latch 304 switch 102 may rest unactuated toward the bottom of their respective switch housings 114 and may be biased downward by respective springs. Other switches may be employed that are not biased and switches that are biased may be biased in any desired direction.

When the switch 102 is unactuated, the switch places a magnet 514 or 516 in a position to act upon the latch bolt 122 so as to move the latch bolt 122 toward the switch assembly 102. Actuation of the first switch 102 moves the left side magnet assembly 512 such that a magnet that repulses the latch bolt 122 is moved into a position proximate to the latch bolt 122, thereby moving the latch bolt 122 out of engagement with the strike 106 or strut 150. At 404, the second latch 322 is actuated by moving the second latch switch 102, thereby repulsing the latch bolt 122 of the second latch 322. At 406, the drop-side 306 may be released from the left and right struts 150 by fingers or thumbs of hands that are actuating the left and right side switches 302 and 304. Once released, the drop-side 306 may be lowered to rest alongside the fixed front-side 310, as depicted in FIG. 4, which illustrates the drop-side crib 300 of FIG. 3 with the drop-side 302 in an open position 309.

One method of latching a first apparatus to a second apparatus, includes moving an actuator 510 that is attached to the first apparatus and has a north-pole magnet 514 and a south-pole magnet 516 attached to it to a first position, which causes a magnet associated with a bolt 122 attached to the second apparatus to extend into the first apparatus, thereby latching the first apparatus to the second apparatus. When the actuator 510 is moved to a second position, the actuator 510 causes the magnet associated with the bolt 122 to retract from the first apparatus, thereby unlatching the first apparatus from the second apparatus. The method of latching a first apparatus to a second apparatus may include biasing the actuator 510 to the engaging position such that the bolt 122 will be engaged with the first apparatus when the bolt 122 is proximate to the actuator 510. That method may also include latching the second apparatus to the first apparatus by moving the second apparatus into proximity to the first apparatus.

FIG. 5 illustrates an exploded view of an embodiment of a latch 500. The latch 500 includes a moveable actuator body 502 and a latch body 504. The moveable actuator body 502 includes an actuator 510, which may take the form of a sliding button; a magnet assembly 512 that includes a north-pole magnet 514 and a south-pole magnet 516; and a switch housing 508. The latch body 504 includes a latch bolt 520 and a latch housing 522. The latch body may also or alternatively include a spring that may bias the latch bolt 520 to a latched position or an unlatched position. A strike plate 530 is optional and may be mounted adjacent the moveable actuator body 502 and the latch bolt 520. The latch bolt 520 may be retained in its latched position in whole or in part by the strike plate 530.

The moveable actuator body 502 provides actuation for the latch 500, particularly the latch body 504. The actuator 510, here a sliding button, and the magnet assembly 512 may be coupled such that the magnet assembly 512 moves with the actuator 510 sliding button. For example, the actuator 510 sliding button may be attached to the magnet assembly 512 by interference fit, snap-coupling prongs extending from the actuator 510 to couple to the magnet assembly 512 when pressed together, or snap-coupling prongs extending from the magnet assembly 512 to couple to the actuator 510 when pressed together, or by one or more screws extending from one part 510, 512 of the moveable actuator body 502 to the other part 510, 512 of the moveable actuator body 502.

The actuator 510 and the magnet assembly 512 may furthermore connect to one another through the switch body housing 508 or a portion of the housing 508, such as a first switch body housing portion 524 as illustrated in FIG. 5. For example, as shown in FIG. 5, the sliding button 510 may fit into a first portion 524 of the housing 508 such that the sliding button actuator 510 is surrounded by the first portion 524 of the housing 508 and moveable in the first portion 524 of the housing 518. A second portion 526 of the switch body housing 508 may also be included to partially or fully enclose the magnet assembly 512. That second portion 526 of the switch body housing 508 may attach to the first portion 524 of the switch body housing 508 as desired, for example though one or more screws, interference fit, or snap-coupling prongs. Other, additional, or fewer portions may be included in the moveable actuator body 502 housing 508 as desired.

Other actuating devices may be used alternatively to the sliding button actuator 510 illustrated in FIG. 5, as desired. For example, a pushbutton may be used that, when actuated by pressing, alternately places the north-pole magnet and the south-pole magnet in a position to apply a magnetic force to the latch bolt 520 or latch body 504.

The latch body 504 housing may also have multiple portions as desired, such as latch body attachment portion 528 and latch body cap 526.

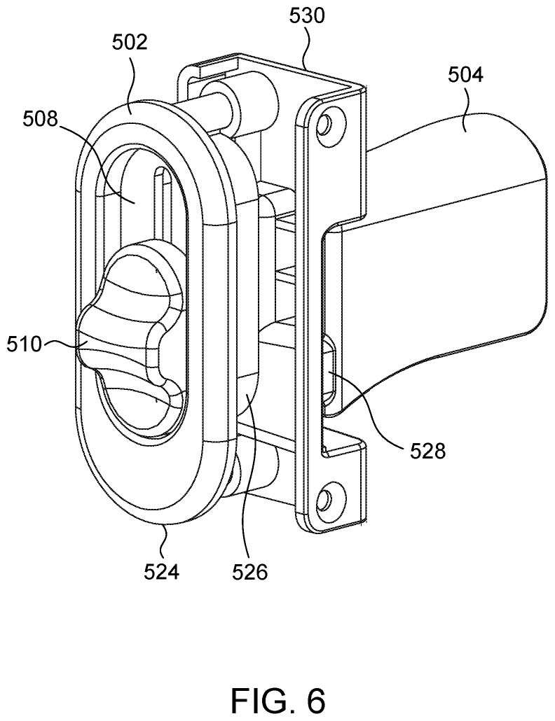

FIG. 6 illustrates the latch 500 illustrated in FIG. 5 with the components of latch 500 combined for use on a crib or other apparatus configured with the latch bolt 520 engaged with the strike plate 530.

In one embodiment of a magnetic latch 500, a bolt facing north-pole magnet 514 and a bolt facing south-pole magnet 516 are attached to a moveable actuator 510 that is coupled to a first portion of an apparatus that is to be latched. A strike plate 530 is also coupled to the first portion of the apparatus to latch with the bolt 122. The strike plate 530 may be located near, but not necessarily in contact with, the moveable actuator 510. A bolt 122 responsive to the bolt facing north-pole magnet 514 and the bolt facing south-pole magnet 516 and adjacent the actuator 510 is coupled to the second portion of the apparatus. The bolt 122 is moveable in relation to the first portion of the apparatus to engage the strike plate 530 when the moveable actuator 510 is in a first position and to disengage the strike plate 530 when the moveable actuator 510 is in a second position.

A crib 300 having a drop-side 306 moveably attached to the crib 300 by one or more hinges may include a moveable actuator 510 having a bolt facing north-pole magnet 514 and a bolt facing south-pole magnet 516. A strike 530 may also be coupled to the crib 300 adjacent the moveable actuator 510 on an opposite side of a crib strut 150 from the moveable actuator 510, as may be seen in FIG. 2. A bolt 122 having a bolt magnet 532 incorporated therein is attached to the drop-side 306. The drop-side 306 is moveable in relation to the crib 300 such that the bolt 122 magnetically engages the strike 530 when the bolt 122 is adjacent the strike 530 and the moveable actuator 510 is in a first position and such that the bolt 122 disengages the strike 530 when the moveable actuator 510 is in a second position. In such an embodiment, the strike may move the bolt 122 to a retracted position when the drop-side 306 is moved to engage the strike 530 by an angle in the strike 530. Where the bolt 122 is moved to its retracted or unlatched position by the strike 530, the bolt 122 may move against a slanted portion of the strike 530 and that slanted portion of the strike 530 may press the bolt 122 to its retracted position. Once the bolt 122 moves past the sloping portion of the strike 530, the bolt 122 may be drawn out to its extended or latched position by the moveable actuator 510 if the moving actuator is in its latching position.

While specific embodiments of the invention have been described in detail, it should be appreciated by those skilled in the art that various modifications and alternations and applications could be developed in light of the overall teachings of the disclosure. Accordingly, the particular arrangements, apparatuses, and methods disclosed are meant to be illustrative only and not limiting as to the scope of the invention.

What is claimed is:

1. A magnetic latch, comprising:
a moveable actuator having a north-pole facing outward oriented magnet and a south-pole facing outward oriented magnet attached thereto;
a bolt responsive to the north-pole magnet and the south-pole magnet adjacent the moveable actuator;
wherein a magnetic force applied to the bolt moves the bolt toward the moveable actuator when the movable actuator is in a first position and moves the bolt away from the moveable actuator when the movable actuator is in a second position.

2. The magnetic latch of claim 1, wherein the bolt is one of magnetized with its north-pole facing the moveable actuator and adjacent to a latch magnet with a north-pole facing the moveable actuator.

3. The magnetic latch of claim 1, wherein the bolt is one of magnetized with its south-pole facing the moveable actuator and adjacent to a latch magnet with a south-pole facing the moveable actuator.

4. The magnetic latch of claim 1, wherein the bolt is magnetized and acts as the bolt magnet.

5. The magnetic latch of claim 1, further comprising a spring biasing the bolt.

6. The magnetic latch of claim 1, a spring biasing the moveable actuator.

7. The magnetic latch of claim 6, wherein the spring biases the moveable actuator to a latching position.

8. The magnetic latch of claim 1, further comprising an actuator housing connected to the moveable actuator and connectable to a first separable portion of an apparatus to be latched.

9. The magnetic latch of claim 8, further comprising a latch housing connected to the bolt and connectable to a first separable portion of an apparatus to be latched.

10. The magnetic latch of claim 8, further comprising a strike to engage the bolt.

11. The magnetic latch of claim 1, wherein the moveable actuator is attached to a first apparatus that is latchable and moveable in relation to a second apparatus.

12. The magnetic latch of claim 11, wherein the first apparatus has a void for entry of the bolt.

13. The magnetic latch of claim 12, wherein the latch body is attached to the second apparatus.

14. The magnetic latch of claim 13, further comprising a strike attached to the first apparatus and wherein the bolt engages the strike when the moveable actuator is in a first position and the bolt disengages the strike when the moveable actuator is in a second position.

15. A method of operating a latch, comprising:
moving an actuator that is attached to a first structure to be latched, the actuator having a bolt facing north-pole magnet and a bolt facing south-pole magnet, to a first position, thereby causing a magnet associated with a bolt attached to a second structure to be latched to extend into the first structure, thereby latching the first structure to the second structure; and
moving the actuator to a second position, thereby causing the magnet associated with the bolt to retract from the first structure, thereby unlatching the first structure from the second structure.

16. The method of operating a latch of claim 15, further comprising biasing the actuator to the first position.

17. The method of latching a first apparatus to a second apparatus of claim 16, further comprising latching the second apparatus to the first apparatus by moving the second apparatus into proximity with the first apparatus.

18. A magnetic latch for a drop-side crib, comprising:
a moveable actuator having a bolt facing north-pole magnet and a bolt facing south-pole magnet, the moveable actuator attached to the crib;
a strike coupled to the crib adjacent the moveable actuator; and
a bolt having a bolt magnet incorporated therein, the bolt attached to a drop-side moveable in relation to the crib such that the bolt magnetically engages the strike when the bolt is adjacent the strike and the moveable actuator is in a first position and such that the bolt disengages the strike when the moveable actuator is in a second position.

19. The magnetic latch of claim 18, wherein the strike moves the bolt to a retracted position when the drop-side is moved to engage the strike.

20. The magnetic latch of claim 19, wherein the moveable actuator moves the bolt to an extended latching position when the latch-side is moved to a closed position against the crib.
